(19) United States
(12) Patent Application Publication
(10) Pub. No.: US 2021/0142132 A1
(43) Pub. Date: May 13, 2021

(54) IMAGE FORMING APPARATUS, METHOD, AND RECORDING MEDIUM

(71) Applicant: Hiroki SHIBUTA, Kanagawa (JP)

(72) Inventor: Hiroki SHIBUTA, Kanagawa (JP)

(73) Assignee: Ricoh Company, Ltd., Tokyo (JP)

(21) Appl. No.: 17/090,083

(22) Filed: Nov. 5, 2020

(30) Foreign Application Priority Data
Nov. 13, 2019 (JP) 2019-205800

(51) Int. Cl. G06K 15/00

(52) U.S. Cl. CPC G06K 15/4085

(57) ABSTRACT

An image forming apparatus includes processing circuitry; and a memory storing computer-executable instructions that cause the processing circuitry to perform printing onto a sheet; discharge the sheet onto which the printing has been performed; and control the sheet to be discharged in a manner such that a location of a paper jam can be identified among a plurality of sheets, upon detecting that the paper jam has occurred while printing onto the plurality of sheets.

### CROSS-REFERENCE TO RELATED APPLICATION

The present application is based on and claims priority under 35 U.S.C. § 119 to Japanese Patent Application No. 2019-205800, filed on Nov. 13, 2019, the contents of which are incorporated herein by reference in their entirety.

### BACKGROUND OF THE INVENTION

### 1. Field of the Invention

The present invention relates to an image forming apparatus, a method, and a recording medium.

### 2. Description of the Related Art

Patent Document 1 discloses a technique for inserting an insertion sheet to extract a location where a paper jam has occurred (among a plurality of discharged paper sheets).

Patent Document 1: Japanese Unexamined

Patent Application Publication No. 2001-220053

### SUMMARY OF THE INVENTION

According to one aspect of the present invention, there is provided an image forming apparatus including processing circuitry; and a memory storing computer-executable instructions that cause the processing circuitry to perform printing onto a sheet; discharge the sheet onto which the printing has been performed; and control the sheet to be discharged in a manner such that a location of a paper jam can be identified among a plurality of sheets, upon detecting that the paper jam has occurred while printing onto the plurality of sheets.

### BRIEF DESCRIPTION OF THE DRAWINGS

FIG. 1 is a hardware configuration diagram of a multifunction peripheral (MFP) according to an embodiment of the present invention;

FIG. 2 is a diagram illustrating the functional configuration of the MFP according to an embodiment of the present invention;

FIG. 3 is a flowchart illustrating a procedure of a process by the MFP according to an embodiment of the present invention;

FIG. 4 is a diagram illustrating an example of control when a paper jam has occurred, performed by a sheet discharge control unit according to an embodiment of the present invention;

FIG. 5 is a diagram illustrating an example of shifting performed by a sheet discharging unit according to an embodiment of the present invention;

FIG. 6 is a diagram illustrating an example of a shifting performed by the sheet discharging unit according to an embodiment of the present invention;

FIGS. 7A and 7B illustrate another example of control when a paper jam has occurred, performed by the sheet discharge control unit according to an embodiment of the present invention;

FIG. 8 is a diagram illustrating an example of a report of a location where a paper jam has occurred, displayed by a reporting unit according to an embodiment of the present invention; and

FIG. 9 is a diagram illustrating an example of a stapling operation by the sheet discharging unit according to an embodiment of the present invention.

### DETAILED DESCRIPTION OF THE PREFERRED EMBODIMENTS

In the conventional technology, there has been a problem in that an insertion sheet is inserted into the location where a paper jam has occurred (among a plurality of discharged paper sheets), thereby consuming wasted paper sheets every time a paper jam occurs.

A problem to be addressed by an embodiment of the present invention is to enable the location (among a plurality of discharged paper sheets) where a paper jam has occurred to be easily identified, without wasting paper sheets.

Hereinafter, an embodiment of the present invention will be described with reference to the drawings.

### Hardware Configuration of an MFP 100

FIG. 1 is a hardware configuration diagram of a multifunction peripheral (MFP) 100 according to an embodiment of the present invention. The MFP 100 illustrated in FIG. 1 is an example of an “image forming apparatus”. The MFP 100 is an apparatus having a scanner function, a printer function, a fax function, and the like. As illustrated in FIG. 1, the MFP 100 includes a controller 110, a short range communication circuit 120, an engine control unit 130, an operation panel 140, and a network interface (I/F) 150.

Among these, the controller 110 includes a central processing unit (CPU) 101 that is the main unit of a computer, a system memory (MEM-P) 102, a north bridge (NB) 103, a south bridge (SB) 104, an Application Specific Integrated Circuit (ASIC) 106, a local memory (MEM-C) 107 as a storage unit, a hard disk drive (HDD) controller 108, and a hard disk (HD) 109 as a storage unit, and the NB 103 and the ASIC 106 are connected to each other by an Accelerated Graphics Port (AGP) bus 121.

Among these, the CPU 101 is a control unit that performs overall control of the MFP 100. The NB 103 is a bridge for connecting the CPU 101, the MEM-P 102, the SB 104, and the AGP bus 121, and includes a memory controller for controlling reading and writing to the MEM-P 102, a Peripheral Component Interconnect (PCI) master, and an Accelerated Graphic Port (AGP) target.

The MEM-P 102 includes a read-only memory (ROM) 102a, which is a memory for storing programs and data by which each function of the controller 110 is implemented, and a random access memory (RAM) 102b used for loading programs or data and as a rendering memory at the time of memory printing, and the like. The program stored in the RAM 102b may be provided by being recorded in a computer-readable recording medium such as a compact disk read-only memory (CD-ROM), a CD recordable (CD-R), or a digital versatile disc (DVD) in a file in an installable format or an executable format.

The SB 104 is a bridge for connecting the NB 103 to PCI devices and peripheral devices. The ASIC 106 is an integrated circuit (IC) for image processing applications having hardware elements for image processing and has the role of a bridge connecting the AGP bus 121, a PCI bus 122, the HDD controller 108, and the MEM-C 107, respectively. The ASIC 106 includes a PCI target, an AGP master, an arbitrator (ARB) that forms the core of the ASIC 106, a memory controller that controls the MEM-C 107, a plurality of Direct Memory Access Controllers (DMACs) that rotate image data by a hardware logic and the like, and a PCI unit that performs data transfer between a scanner unit 131 and a printer unit 132 via the PCI bus 122. The ASIC 106 may be connected to an interface of a Universal Serial Bus (USB) or an interface of the IEEE 1394 (Institute of Electronic and Electronic Engineers 1394).

The MEM-C 107 is a local memory used as an image buffer for copying and a code buffer. The HD 109 is a storage device for storing image data, storing font data used for printing, and storing forms. The HD 109 controls the reading or writing of data to the HD 109 according to the control of the CPU 101. The AGP bus 121 is a bus interface for a graphics accelerator card proposed for speeding up graphics processing, and can increase the speed of a graphics accelerator card by directly accessing the MEM-P 102 with high throughput.

The short range communication circuit 120 is provided with an antenna 120a. The short range communication circuit 120 is a communication circuit such as that of Near Field Communication (NFC), Bluetooth (registered trademark), and the like.

The engine control unit 130 further includes the scanner unit 131 and the printer unit 132. The operation panel 140 includes a panel display unit 140a, such as a touch panel, which displays a current setting value, a selection screen, and the like and accepts input from an operator; and an operation panel 140b including a numeric pad for accepting a setting value of an image forming condition such as a density setting condition and a start key for accepting a copy start instruction. The controller 110 controls the entire MFP 100 and controls, for example, rendering, communication, input from the operation panel 140, and the like. The scanner unit 131 or the printer unit 132 includes an image processing unit for error diffusion or gamma conversion, etc.

In the MFP 100, an application switching key of the operation panel 140 allows a selection by sequentially switching among the document box function, the copy function, the printer function, and the fax function. When the document box function is selected, the mode is set to a document box mode, when the copy function is selected, the mode is set to a copy mode, when the printer box function is selected, the mode is set to a printer mode, and when the fax function is selected, the mode is set to a fax mode.

The network I/F 150 is an interface for performing data communication using a communication network. The short range communication circuit 120 and the network I/F 150 are electrically connected to the ASIC 106 via the PCI bus 122.

### Functional Configuration of the MFP 100

FIG. 2 is a diagram illustrating a functional configuration of the MFP 100 according to an embodiment of the present invention. As illustrated in FIG. 2, the MFP 100 includes a printing unit 201, a sheet discharging unit 202, a paper jam detecting unit 203, a sheet discharge control unit 204, and a reporting unit 207.

The printing unit 201 performs printing on a paper sheet based on a print job. The printing unit 201 can print the same print target document (document to be printed) on a plurality of sheets in units or copies, in units of each page, and the like based on the setting of the print job.

The sheet discharging unit 202 discharges the sheet on which printing has been performed by the printing unit 201. The sheet discharging unit 202 has an offset stack function that can shift the discharge position of the sheets discharged to a stack tray 202A included in the sheet discharging unit 202, with respect to each unit of pages (for example, in units of copies, in units of each page, and the like) in order to clarify the separation position between the respective units of pages of the printed matter.

The paper jam detecting unit 203 detects the occurrence of a paper jam during printing. For example, the paper jam detecting unit 203 detects the occurrence of a paper jam upon receiving a report of the occurrence of the paper jam from the printing unit 201.

When the occurrence of a paper jam is detected by the paper jam detecting unit 203 during printing of a plurality of sheets by the printing unit 201, the sheet discharge control unit 204 discharges the sheet from the sheet discharging unit 202 in a manner such that the location where the paper jam has occurred (among a plurality of discharged paper sheets) can be identified. The sheet discharge control unit 204 includes a shift control unit 205 and a direction control unit 206. The shift control unit 205 shifts the discharge position of the paper sheet discharged from the sheet discharging unit 202 at the location where the paper jam has occurred. The direction control unit 206 causes the printing content to be printed by the printing unit 201, corresponding to the location where the paper jam has occurred, to be printed on a paper sheet in a direction different from that before the paper jam has occurred.

When a paper jam occurs during printing of a plurality of sheets by the printing unit 201, the reporting unit 207 reports the occurrence of the paper jam such that the location where the paper jam has occurred can be identified. For example, the reporting unit 207 displays information representing the location where the paper jam has occurred on the panel display unit 140a (see FIG. 1) of the operation panel 140.

Among the functions of the MFP 100 described above, for example, the printing unit 201 and the sheet discharging unit 202 are implemented by the printer unit 132 illustrated in FIG. 1. For example, the paper jam detecting unit 203, the sheet discharge control unit 204, and the reporting unit 207 are implemented by executing a program by the CPU 101 illustrated in FIG. 1.

Each of the functions of the MFP 100 described above may be implemented by one or more processing circuits. As used herein, a “processing circuit” includes a processor programmed to execute each function by software, such as a processor implemented in electronic circuits, an Application Specific Integrated Circuit (ASIC), a digital signal processor (DSP), a field programmable gate array (FPGA), or a conventional circuit module designed to execute each function as described above.

### Procedure of Identifying Process by the MFP 100

FIG. 3 is a flowchart illustrating a procedure of an identifying process performed by the MFP 100 according to an embodiment of the present invention. For example, the series of processes illustrated in FIG. 3 are executed when a plurality of printing operations are performed by the printing unit 201.

First, in step S301, it is determined whether the paper jam detecting unit 203 has detected the occurrence of a paper jam. In step S301, when it is determined that the occurrence of a paper jam is not detected (No in step S301), the paper jam detecting unit 203 executes the process of step S301 again.

On the other hand, when it is determined in step S301 that the occurrence of the paper jam is detected (Yes in step S301), in step S302, the sheet discharging unit 202 determines whether the sheet discharge control unit 204 is executing the offset stack mode.

In step S302, when it is determined that the offset stack mode is not being executed by the sheet discharging unit 202 (No in step S302), the shift control unit 205 shifts the discharge position of the paper sheets discharged from the sheet discharging unit 202 at the location where the paper jam has occurred (step S303). Then, the MFP 100 ends the series of processes illustrated in FIG. 3.

On the other hand, in step S302, when it is determined that the offset stack mode is being executed by the sheet discharging unit 202 (Yes in step S302), in step S304, the sheet discharge control unit 204 determines whether there is a paper tray of the printing unit 201 filled with paper sheets in a direction different from that before the paper jam.

In step S304, when it is determined that there is a paper tray of the printing unit 201 filled with paper sheets in a direction different from that before the paper jam (Yes in step S304), in step S305, the direction control unit 206 causes the printing content, which was supposed to be printed by the printing unit 201 on the paper sheet at the location where the paper jam has occurred, to be printed on a paper sheet in a direction different from that before the paper jam has occurred. In step S306, the direction control unit 206 causes the sheet discharging unit 202 to discharge the paper sheet in the paper sheet direction different from that before the paper jam, on which printing has been performed in step S305. Thereafter, the MFP 100 ends the series of processes illustrated in FIG. 3.

On the other hand, in step S304, when it is determined that the paper tray of the printing unit 201 is not filled with paper sheets in a direction different from that before the paper jam (No in step S304), in step S307, the reporting unit 207 reports the occurrence of the paper jam such that the location where the paper jam has occurred (among a plurality of discharged paper sheets) can be identified. Then, the MFP 100 ends the series of processes illustrated in FIG. 3.

### Example of Control When Paper Jam Has Occurred, Performed by the Sheet Discharge Control Unit 204

FIG. 4 is a diagram illustrating an example of control when a paper jam has occurred, performed by the sheet discharge control unit 204 according to an embodiment of the present invention. As illustrated in FIG. 4, when a paper jam occurs during printing of a plurality of sheets by the printing unit 201, the sheet discharge control unit 204 can shift the discharge position of the paper sheets at the location where the paper jam has occurred, by the offset stack function of the sheet discharging unit 202. Accordingly, the user can easily identify the location where the sheet discharge position is shifted, among the plurality of sheets discharged to the stack tray 202A from the sheet discharging unit 202, as the location where the paper jam has occurred (among a plurality of discharged paper sheets). Therefore, according to the MFP 100 of the present embodiment, the location where the paper jam has occurred can be easily identified without wasting paper sheets.

### Example of Shift by the Sheet Discharging Unit 202

FIGS. 5 and 6 illustrate examples of the shift by the sheet discharging unit 202 according to an embodiment of the present invention. FIG. 5 illustrates an example in which the discharge position of a plurality of sheets discharged from the sheet discharging unit 202 is shifted in units of copies by the offset stack function of the sheet discharging unit 202. FIG. 6 illustrates an example in which the discharge position of a plurality of sheets discharged from the sheet discharging unit 202 is shifted in units of each page by the offset stack function of the sheet discharging unit 202.

As illustrated in FIGS. 5 and 6, the MFP 100 according to the present embodiment can shift the discharge position of a plurality of sheets discharged from the sheet discharging unit 202 to the stack tray 202A for each unit of sheets, such as in units or copies or in units of each page, by the offset stack function (offset stack mode) included in the sheet discharging unit 202. Accordingly, the user can easily identify the location where the sheet is shifted, among the plurality of sheets discharged to the stack tray 202A from the sheet discharging unit 202, as the separation position between the respective units of sheets.

For example, when the print target document is formed of page 1, page 2, . . . , and page n, and when this print target document is to be printed in “units of copies” to print an n number of copies, as illustrated in FIG. 5, the MFP 100 according to the present embodiment collectively prints and discharges the first copy, and then collectively prints and discharges the second copy, the third copy, . . . , and the nth copy, one after the other. At this time, the sheet discharging unit 202 shifts the discharge position of the paper sheets at each separation position between the copies.

For example, when the print target document is formed of page 1, page 2, . . . , and page n, and the print target document is printed in “units of each page” to print an m number of copies, as illustrated in FIG. 6, the MFP 100 according to the present embodiment collectively prints and discharges an m number of sheets of page 1, and then collectively prints and discharges an m number of sheets of page 2, an m number of sheets of page 3, . . . , and an m number of sheets of page n, one after the other. At this time, the sheet discharging unit 202 shifts the discharge position of the paper sheets at each separation position between the units of each page.

### Another Example of Control When Paper Jam Has Occurred, by the Sheet Discharge Control Unit 204

FIGS. 7A and 7B are diagrams illustrating another example of the control when the paper jam has occurred, performed by the sheet discharge control unit 204 according to an embodiment of the present invention. FIG. 7A illustrates the paper sheet direction of a plurality of paper sheets discharged by the sheet discharging unit 202 when there is no paper jam. FIG. 7B illustrates the paper sheet direction of a plurality of paper sheets discharged by the sheet discharging unit 202 when a paper jam has occurred.

As illustrated in FIG. 7B, when a plurality of sheets are discharged by the sheet discharging unit 202 in the offset stack mode, and a paper jam occurs, the sheet discharge control unit 204 causes the printing content, which was supposed to be printed by the printing unit 201 on the paper sheet at the location where the paper jam has occurred, to be printed on a paper sheet in a direction (in the example illustrated in FIG. 7B, the horizontal direction) different from that before the paper jam has occurred.

Accordingly, the user can easily identify the location where the discharge position of paper sheets is shifted among a plurality of sheets discharged from the sheet discharging unit 202, as the separation position between the units of sheets, and can also easily identify the location where the direction of the paper sheets is changed as the location where the paper jam has occurred. Therefore, according to the MFP 100 of the present embodiment, the location where the paper jam has occurred can be easily identified without wasting paper sheets.

The method of making the paper direction different at the location where the paper jam has occurred can also be applied to an image forming apparatus without the offset stack function.

### Example of Report of Location Where Paper Jam Has Occurred

FIG. 8 is a diagram illustrating an example of a report of a location where a paper jam has occurred, given by the reporting unit 207 according to an embodiment of the present invention. In the method illustrated in FIG. 7, when there are not enough sheets that are in a different direction from that before the paper jam has occurred, it is not possible to implement the above-described method.

Accordingly, in the MFP 100 according to the present embodiment, when the sheet discharging unit 202 is discharging a plurality of sheets in the offset stack mode, and there are not enough paper sheets in a paper sheet direction different from that before the occurrence of the paper jam, the reporting unit 207 reports the occurrence of a paper jam such that the location where the paper jam has occurred can be identified.

Accordingly, the user can easily identify the location where the paper jam has occurred, based on the report content. Therefore, according to the MFP 100 of the present embodiment, the location where the paper jam has occurred can be easily identified without wasting paper sheets.

As an example of the above, in FIG. 8, the information (in the example illustrated in FIG. 8, “recovered from the paper jam at the image of the XXXth sheet in the YYYth copy”) by which the location where the paper jam has occurred (the copy number and the sheet number) can be identified, is displayed as a banner on the panel display unit 140a of the operation panel 140 included in the MFP 100.

For example, the MFP 100 stores information representing the location where the paper jam has occurred and displays information representing the location where the paper jam has occurred on the panel display unit 140a at the time of recovery from the paper jam, so that the user can confirm the location where the paper jam has occurred and confirm whether there are any missing pages or duplicate pages.

### Example of Stapling Operation by the Sheet Discharging Unit 202

FIG. 9 is a diagram illustrating an example of a stapling operation by the sheet discharging unit 202 according to an embodiment of the present invention. FIG. 9 illustrates an example in which a plurality of sheets discharged from the sheet discharging unit 202 to the stack tray 202A are bundled in units of each page by staples in a staple mode of the sheet discharging unit 202.

As illustrated in FIG. 9, the MFP 100 according to the present embodiment can bundle a plurality of sheets discharged to the stack tray 202A from the sheet discharging unit 202 with staples, for each unit of sheets such as in units of copies and in units of each page, by the staples of the sheet discharging unit 202.

Note that when a paper jam occurs when the MFP 100 according to the present embodiment is printing in the staple mode, it is not possible to apply the method of shifting the sheets at the location where the paper jam has occurred (see FIG. 4) or the method of causing the paper sheet direction to be different at the location where the paper jam has occurred (see FIG. 7), and, therefore, the method of reporting the location where the paper jam has occurred (see FIG. 8) is applied.

Accordingly, the user can easily identify the location where the paper jam has occurred based on the report content. Therefore, according to the MFP 100 of the present embodiment, the location where the paper jam has occurred can be easily identified without wasting paper sheets.

As described above, the MFP 100 according to one embodiment of the present invention includes the printing unit 201 for printing on paper sheets, the sheet discharging unit 202 for discharging the paper sheets on which printing has been performed by the printing unit 201, and the sheet discharge control unit 204 for discharging the paper sheets from the sheet discharging unit 202 in a mode in which the location where the paper jam has occurred can be identified (shifting the paper sheet discharge position or printing on a paper sheet in a different paper direction) when a paper jam occurs during the printing of a plurality of sheets by the printing unit 201.

Accordingly, with the MFP 100 according to an embodiment of the present invention, it is possible to easily identify the location where the paper jam has occurred among a plurality of discharged sheets. Accordingly, according to the MFP 100 according to an embodiment of the present invention, the location where the paper jam has occurred can be easily identified without wasting paper sheets.

According to one embodiment of the present invention, the location where a paper jam has occurred can be easily identified, without consuming wasted paper sheets.

The image forming apparatus, the method, and the recording medium are not limited to the specific embodiments described in the detailed description, and variations and modifications may be made without departing from the spirit and scope of the present invention.

What is claimed is:

1. An image forming apparatus comprising:
processing circuitry; and
a memory storing computer-executable instructions that cause the processing circuitry to:
perform printing onto a sheet;
discharge the sheet onto which the printing has been performed; and
control the sheet to be discharged in a manner such that a location of a paper jam can be identified among a plurality of sheets, upon detecting that the paper jam has occurred while printing onto the plurality of sheets.

2. The image forming apparatus according to claim 1, wherein the processing circuitry is further caused to:
shift a discharge position, to which the sheet is discharged, at the location of the paper jam, upon detecting that the paper jam has occurred while printing onto the plurality of sheets.

3. The image forming apparatus according to claim 1, wherein the processing circuitry is further caused to:
print a printing content corresponding to the location of the paper jam, onto a sheet in a sheet direction different from a sheet direction before the paper jam has occurred, upon detecting that the paper jam has occurred while printing onto the plurality of sheets.

4. The image forming apparatus according to claim 3, wherein the processing circuitry is further caused to:
print the printing content corresponding to the location of the paper jam, onto the sheet in the sheet direction different from the sheet direction before the paper jam has occurred, upon detecting that the paper jam has occurred while discharging the plurality of sheets in an offset stack mode.

5. The image forming apparatus according to claim 1, wherein the processing circuitry is further caused to:
report that the paper jam has occurred such that the location of the paper jam can be identified, upon detecting that the paper jam has occurred while printing onto the plurality of sheets, instead of or in addition to discharging the sheet in the manner such that the location of the paper jam can be identified.

6. A method performed by an image forming apparatus that performs printing onto a sheet and discharges the sheet onto which the printing has been performed, the method comprising:
controlling the sheet to be discharged in a manner such that a location of a paper jam can be identified among a plurality of sheets, upon detecting that the paper jam has occurred while printing onto the plurality of sheets.

7. A non-transitory computer-readable recording medium storing a program that causes a computer to execute a process performed in an image forming apparatus that performs printing onto a sheet and discharges the sheet onto which the printing has been performed, the process comprising:
controlling the sheet to be discharged in a manner such that a location of a paper jam can be identified among a plurality of sheets, upon detecting that the paper jam has occurred while printing onto the plurality of sheets.
